(19) United States
(12) Patent Application Publication
(10) Pub. No.: US 2019/0060818 A1
(43) Pub. Date: Feb. 28, 2019

(54) FILTER INCLUDING NANOFIBER, APPARTUS AND METHOD MANUFACTURING THE SAME

(71) Applicant: DAE CHANG CO., LTD., Jeongeup-si (KR)

(72) Inventors: Joon Dong JI, Suwon-si (KR); Jin Hyok AN, Hwaseong-si (KR)

(73) Assignee: DAE CHANG CO., LTD.

(21) Appl. No.: 15/690,223

(22) Filed: Aug. 29, 2017

(30) Foreign Application Priority Data
Aug. 22, 2017 (KR) 10-2017-0106171

(51) Int. Cl. B01D 46/54; B01D 46/00; B01D 39/16; B01D 69/10

(52) U.S. Cl. CPC B01D 46/546; B01D 46/0032; B01D 39/1607; B01D 2239/1233; B01D 2239/025; B01D 2239/0618; B01D 2239/0654; B01D 69/10

(57) ABSTRACT

A filter includes an electrode; a base layer coupled with the electrode; and a nanofiber layer spun on one side of the base layer and coupled, in which the coupling between the nanofiber layer and the base layer is performed as the nanofiber layer is adsorbed on the base layer by an electric field generated by supplying power to the electrode.

### CROSS-REFERENCE TO RELATED APPLICATION(S)

This application claims benefit of priority to Korean Patent Application No. 10-2017-0106171 filed on Aug. 22, 2017 in the Korean Intellectual Property Office, the disclosure of which is incorporated herein by reference in its entirety.

### BACKGROUND

### 1. Field

The present invention relates to a filter including nanofiber, and a method and apparatus for manufacturing the same.

### 2. Description of Related Art

Generally, when sucking air in the atmosphere, an air filter may prevent foreign materials such as dirt, dust, or the like included in the atmosphere from penetrating into a filter medium, thereby supplying purified air. However, a foreign material smaller than the filter, or, in particular, a heavy metal included in the air may not be filtered out by the filter but be discharged. In an existing air filter, power is supplied to a filtering portion to collect a heavy metal in the air, thereby colleting the heavy metal through electromagnetic force. Further, the existing air filter may also filter out a foreign material having a particle size larger than a filtering hole formed in a filtering portion of the filter. Accordingly, a cross-sectional area of the filtering hole may be reduced to increase filtering performance, but this may cause decrease in flow rate when filtered fluid flows, and reduced lifespan of the filter.

### Related Art Document

(Patent Document 1) Korean Patent Laid-Open Publication No. 2017-0060875 (Jun. 2, 2017)

### SUMMARY

An object of the present invention is to provide a filter including a base layer and a nanofiber layer, in which the base layer and the nanofiber layer are more firmly coupled by an electric field generated by an electrode.

An object of the present invention is to provide a filter including a base layer and a nanofiber layer, in which power is provided to increase force for adsorbing foreign materials and adsorptive force duration at the time of performing a filtering function.

An object of the present invention is to provide an apparatus for manufacturing a filter including a base layer and a nanofiber layer, in which the base layer and the nanofiber layer are more firmly coupled by an electric field generated by an electrode.

An object of the present invention is to provide a method for manufacturing a filter including a base layer and a nanofiber layer, in which the base layer and the nanofiber layer are more firmly coupled by an electric field generated by an electrode.

According to an embodiment of the present invention, a filter includes: an electrode; a base layer coupled with the electrode; and a nanofiber layer spun on one side of the base layer and coupled, in which the coupling between the nanofiber layer and the base layer is performed as the nanofiber layer is adsorbed on the base layer by an electric field generated by supplying power to the electrode.

The electrode may be formed of a metal or an alloy.

The electrode may include a coated area.

The electrode, the base layer, and the nanofiber layer may have predetermined elasticity so that the filter is flexible.

The electrode may be formed to have a diameter or a thickness of 0.5 mm or less.

The electrode may be disposed between the base layer and the nanofiber layer.

The electrode may extend while changing a direction thereof one time or more in a section in which the electrode extends from one end to the other end.

The electrode may be coupled with the base layer by printing.

One or more of the electrode and the nanofiber layer may include silver having a sterilization function.

The electrode may be formed in a film form and may be coupled with the base layer through surface contact.

The filter may further include a controlling part securing different signals depending on a change in resistance generated at both ends of the electrode and performing a control corresponding to the signal.

The signal may correspond to a resistance value, and an intensity of a current provided to the electrode may be determined depending on the resistance value.

A current provided to the electrode may be provided in a manner selected from a continuous manner, a periodic manner, and a discontinuous manner.

The electrode may include one or more of a positive electrode and a negative electrode.

A position at which the electrode and the base layer are coupled with each other may include an edge of the base layer.

The filter may further include a conductor or a semiconductor at one side of the base layer, in which nanofiber is electrospun on one side of the conductor or the semiconductor.

According to another embodiment of the present invention, an apparatus for manufacturing a filter includes: a transferring part transferring a base layer on which a terminal is prepared; a spinning part spinning nanofiber on the base layer; and a power supplying part supplying power to the terminal, in which the spinning part spins the nanofiber while the power is supplied.

According to another embodiment of the present invention, a method for manufacturing a filter includes: preparing a conductive terminal on one side of a porous base layer; transferring, by a transferring part, the base layer to a spinning part; supplying, by a power supplying part, power to the terminal; and adsorbing nanofiber spun by the spinning part on the base layer by an electric field formed at the terminal.

### BRIEF DESCRIPTION OF DRAWINGS

FIG. 1 is an exploded perspective view of a filter according to an embodiment of the present invention.

FIG. 2 is an exploded perspective view of a filter according to another embodiment of the present invention.

FIG. 3 is an exploded perspective view of a filter according to still another embodiment of the present invention.

FIG. 4 is a view illustrating an apparatus for manufacturing a filter according to an embodiment of the present invention.

FIG. 5 is a flowchart illustrating a method for manufacturing a filter according to an embodiment of the present invention.

### DETAILED DESCRIPTION

Hereinafter, embodiments of the present invention will be described with reference to the accompanying drawings. However, the embodiments are merely illustrative and the present invention is not limited thereto.

In describing the present invention, when a detailed description of well-known technology relating to the present invention may unnecessarily obscure the spirit of the present invention, a detailed description thereof will be omitted. Further, the following terminologies are defined in consideration of the functions in the present invention and may be construed in different ways by the intention of users and operators. Therefore, the definitions thereof should be construed based on the contents throughout the specification.

As a result, the spirit of the present invention is defined by the claims and the following embodiments may be provided to efficiently describe the spirit of the present invention to those skilled in the art.

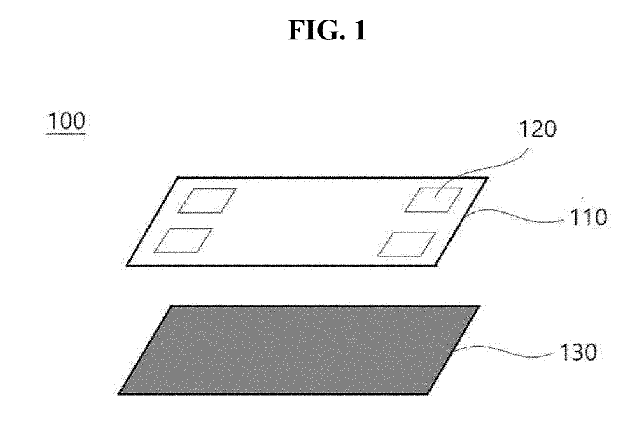

Hereinafter, in FIGS. 1 to 5, a base layer 110 is a member on which nanofiber 1 may be spun, and may be a fiber layer spun using a fine wire thicker than that of non-woven fabric or a nanofiber layer 130. Basically, the base layer 110 serves to form a kind of frame so that the nanofiber layer 130 may be spun in a sheet shape at the time of manufacturing, and may be a porous planar member.

Further, an electrode may be formed of a conductive single metal or alloy, and may have one surface coated. Further, a filter 100 may have predetermined elasticity. Accordingly, elasticity, ductility, and the like of each component may be determined so that the predetermine elasticity is implemented by coupling of the electrode 120, the base layer 110, and the nanofiber layer 130 configuring the filter 100.

Further, the electrode 120 may be formed to have a diameter or a thickness of 0.5 mm or less as will be described below with reference to FIGS. 1 to 3, and may be positioned while being interposed between the nanofiber layer 130 and the base layer 110. This also includes a case in which the electrode 120 is led into the base layer 110.

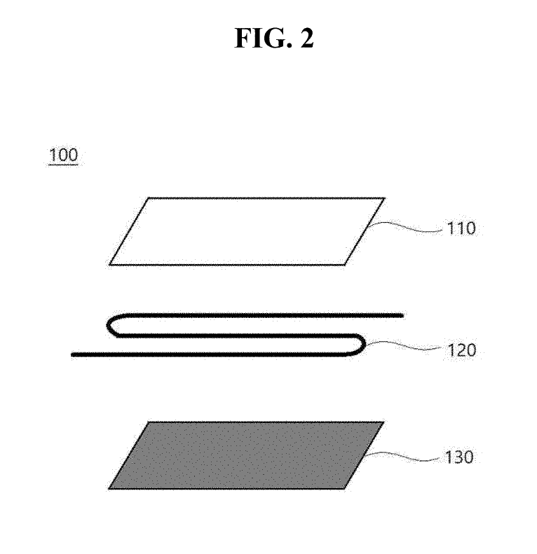

Further, the electrode 120 may extend while changing a direction thereof one time or more in a section in which it extends from one end to the other end. This is an embodiment and will be described below in detail with reference to FIG. 2. Further, the electrode 120 may be printed on one surface of the base layer 110 to be prepared on the base layer 110, and may adhere as a thin film type film.

The electrode 120 described above may include a silver component to perform a sterilization function for fluid passing through the filter 100.

Further, the filter may be manufactured by further including a conductor or a semiconductor at one side of the base layer 110, and electrospinning the nanofiber 1 at one side of the conductor or the semiconductor.

FIG. 1 is an exploded perspective view of a filter 100 according to an embodiment of the present invention.

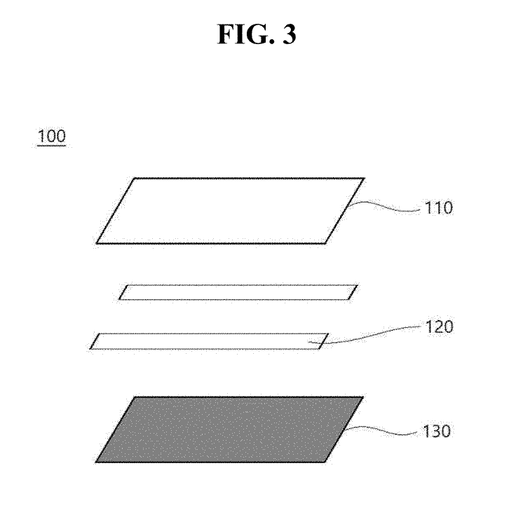

Referring to FIG. 1, the filter 100 may include the base layer 110, the electrode 120, and the nanofiber layer 130. Here, the base layer 110 may be formed of a porous material so that fluid may pass therethrough. For example, the base layer 110 may be non-woven fabric in a thin film form. The base layer 110 may be coupled with the electrode 120. The electrode 120 may be formed in a line form, a film form, a form of a thin film printed on the base layer 110, or the like. The various forms of the electrode 120 as above may include a line form 120a in FIG. 2, and a film form 120b in FIG. 3 by way of example. A filter using the electrode 120 in the illustrated line form will be described.

The electrode 120 may be prepared on the base layer 110 in a state in which the electrode 120 is bonded to the base layer 110 or is led into the base layer 110. For example, in a case in which the base layer 110 is non-woven fabric, the electrode 120 may be disposed in a process of compressing fiber during manufacturing process of the non-woven fabric to be disposed integrally with the non-woven fabric. Alternatively, the electrode 120 may be coupled by adhering one side surface of the manufactured non-woven fabric.

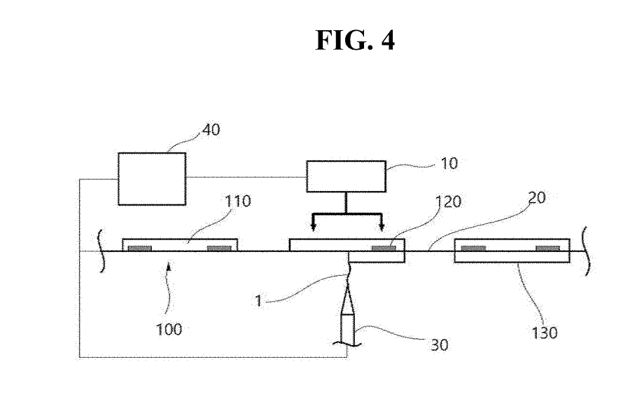

As described above, the electrode 120 may be prepared on the base layer 110, and the nanofiber layer 130 may be stacked on the base layer 110. The nanofiber layer 130 may be formed by accumulatively adsorbing nanofiber 1 (FIG. 4) that is spun by a spinning part 30 (FIG. 4) on the base layer 110.

Here, the reason why the nanofiber 1 (FIG. 4) can be adsorbed on the base layer 110 is that a direction in which the nanofiber 1 (FIG. 4) is spun by the spinning part 30 (FIG. 4) is a direction of the base layer 110 and the nanofiber 1 (FIG. 4) has a predetermined adhesive property due to viscosity, or the like since it is spun in a liquid state. Further, in the present invention, the spun nanofiber 1 (FIG. 4) is induced to be adsorbed to the base layer 110 side by an electric field by power provided to the electrode 120.

As described above, power may be provided to the electrode 120 to adsorbing the nanofiber layer 1 (FIG. 4) on the base layer 110. An electric field is generated in the vicinity of a terminal provided with power, and the nanofiber 1 (FIG. 4) that is spun by the spinning part 30 (FIG. 4) may be adsorbed on the base layer 110 by the generated electric field. That is, density, or the like of the nanofiber layer 130 may be changed depending on the number and a position of the electrode.

The electrode 120 may include one or more of an electrode 120a in a line form and an electrode 120b in a film form. The electrode 120 may not be formed of a porous material, but the nanofiber layer 130 and the base layer 110 are formed as a porous layer and included in the filter 100, thus air may pass. As an area of the electrode 120 on a cross section of the filter 100 based on a flowing direction of fluid is increased, an area of the filter 100 for performing filtering function may be decreased.

Accordingly, as the area on the cross section in the flowing direction of the fluid is decreased due to the electrode 120, the area for performing the filtering function is increased, and thus filtering efficiency may also be improved. In order to achieve such purpose, the electrode 120a in a line form illustrated in FIG. 2 may be disposed, or the electrode 120b in an elongated thin plate form illustrated in FIG. 3 may be disposed. Even in this case, a thickness or a diameter of the electrode 120 may be 0.5 mm or less, and this means that the electrode 120 may be an electrode in a form of a fine wire or a thin plate that may be bent without being damaged when the filter is bent.

Further, the electrode 120 may be coupled to the base layer 110, and the coupling position may be included in an edge of the base layer 110. Although the electrode 120 may also extend from an edge to a central portion, the electrode 120 may be disposed as described above to secure the area for performing the filtering function in order to improve the filtering function as a filter.

Meanwhile, the fluid passing through the filter 100 include gas and liquid. In the case of gas, fine particles included in the air may be filtered out by the nanofiber layer 130 when the air passes through the filter 100. In an embodiment, the nanofiber layer 130 may be used in the filter 100 included or coupled to a cigarette. Further, in a case of liquid fluid, similarly, the nanofiber layer 130 may filter out fine particles mixed in drinking water in a water purification process by way of example.

In the filter 100 used as a filter positioned in a path through which the fluid passes, fine particles may be filtered by the nanofiber layer 130, and particles larger than the fine particles may be filtered by the base layer 110. Here, the base layer 110 may be non-woven fabric, or the like by way of example. The non-woven fabric has through holes formed in directions and sizes that are determined at random so that fluid may pass. Therefore, by manufacturing fine through holes formed in the base layer 110 to have a predetermined size and a predetermined direction, particles larger than fine particles that are filtered out by the nanofiber layer 130 may be filtered out.

Therefore, in this case, the base layer 110 may be disposed toward a front side in a direction in which the fluid moves, and the nanofiber layer 130 may be disposed toward a rear side.

The spinning part 30 (FIG. 4) spinning the nanofiber 1 (FIG. 4) may perform spinning through electrospinning. Other spinning methods such as a method of spinning by generating wind, or the like may also be used. Hereinafter, although a case in which electrospinning is performed is described as an example, the present invention may also be applied to a spinning process using other spinning methods.

The number of spinning part 200 performing electrospinning may be one or more. The electrospinning may be performed so that the nanofiber 1 (FIG. 4) is spun on the base layer 110 at random or is spun to have predetermined directivity. For example, in a case in which the number of spinning part 200 is two, the spinning parts 200 may be disposed at a front side and a rear side in a moving direction of the base layer 110, respectively to overlay nanofiber. That is, the nanofiber layer 130 may be formed of a plurality of layers . In terms of directivity of the overlaid layers, one layer may be arranged at random and the other layer may be formed as a layer having directivity, and vice versa. Further, the both of two layers may also be formed to be arranged at random or formed to have directivity.

Here, if the nanofiber layer 130 is formed as a layer having two directivities, the nanofiber of respective overlaid layers may be formed to have different directivities. The disposition as described above is a structure for improving filtering efficiency, and may structurally inhibit fine particles from passing.

Regarding the electrospinning, specifically, the nanofiber layer 130 formed of the nanofiber 1 (FIG. 4) is formed by an electrospinning (E-S) process, and the nanofiber layers 130 may be fixed to each other by a predetermined bonding force by a random E-S method in which the nanofiber layer 130 is arranged at random and stacked on the base layer 110. Further, the nanofiber layer 130 may be arranged in parallel and stacked on the base layer 110 in one direction by a directional E-S method. In the case of the directional E-S, the nanofiber layer 130 may be formed in different directions at a predetermined time interval.

For example, in the case of the method of forming the nanofiber layer 130 by the random E-S or the directional E-S that is performed on the base layer 110, a polymer material may be discharged by the spinning part 200 through electrospinning and arranged on the base layer 110. In the electrospinning process, an electric repulsive force is generated in the polymer material, and thus the polymer material may be formed in a nano-sized thread form. Therefore, the polymer material may be present in the spinning part 200 in a solvent state. Here, the base layer 110 may be non-woven fabric.

Further, in the case of the directional E-S method, the base layer 110 may move or rotate at a predetermined speed in consideration of a speed at which the nanofiber is spun, and may move or rotate in accordance with a speed at which the nanofiber is formed, such that the nanofiber is arranged.

Further, a direction in which the nanofiber is formed may be partially different. The spinning direction of the nanofiber may be determined through the electrospinning according to a control of a controlling part (not illustrated).

Further, as described above, the adhesive property of the nanofiber 1 (FIG. 4) may also partially contribute to adhesion of the nanofiber 1 (FIG. 4) to the base layer 110 by spinning. In the adhesion between the nanofiber 1 (FIG. 4) and the base layer 110, in order to increase a level of dependence on the adhesive property of the nanofiber 1 (FIG. 4), viscosity of the nanofiber in a liquid state before the nanofiber 1 (FIG. 4) is spun may be more increased, but this may limit a spinning distance of the nanofiber in the spinning process. As a distance between the base layer and the spinning part 30 (FIG. 4) is decreased to spin the nanofiber in a liquid state that is melted at high temperature, a possibility that the base layer is damaged by heat is increased, therefore, it is preferable that the base layer and the spinning part are spaced apart from each other by a predetermined distance, and to this end, the spinning distance needs to be increased.

In order to increase the spinning distance, the nanofiber in a liquid state that is spun from the spinning part 30 (FIG. 4) may have low viscosity. In the case of the nanofiber in a liquid state having low viscosity, the spinning distance may be more increased, and the nanofiber may be spun farther distance toward the base layer. However, as the viscosity is decreased, the viscosity of the spun nanofiber may be decreased. Therefore, the electrode 120 may be disposed to generate an electric field in order to compensate for decrease in the adhesive property caused by the low viscosity.

Accordingly, one or more electrodes 120 may be freely prepared at one side of the base layer 110, and provided so that an electric field generated by the electrode 120 acts from an adhesion surface where the nanofiber layer 130 and the base layer 110 adhere to each other to a side where the nanofiber 1 (FIG. 4) is spun.

Meanwhile, the electrode 120 may be supplied with power from an external device. If the electrode 120 is polarized by being supplied with power from the external device to perform the filtering function, the electrode 120 may be conducted together with the nanofiber layer 130, thus the filter 100 may perform the filtering function by adsorbing fine particles, heavy metal, and the like in the air passing the filter 100.

Here, if the electrode 120 that is supplied with power from the external device is not present, the fine particles and the heavy metal may be collected only with the nanofiber layer 130, but a collecting force by polarity may be reduced as compared to the case in which the electrode 120 is included, and duration of the collecting force, that is, a lifespan may also be reduced.

Therefore, by including the electrode 120 that may be supplied with power from the external device, the collecting force for filtrate and the lifespan of the collecting force may be increased. Although the fine particles and the heavy metal may be structurally filtered out according to density of the nanofiber layer 130 formed of the nanofiber 1 (FIG. 4) described above, the electrode that is supplied with power from the external device is included in order to increase the collecting force and the lifespan of the collecting force.

FIG. 4 is a view illustrating an apparatus for manufacturing a filter according to an embodiment of the present invention.

Referring to FIG. 4, the apparatus for manufacturing a filter may include a power supplying part 10, a transferring part 20, the spinning part 30, and a controlling part 40. The transferring part 20 that transfers the base layer 110 may transfer the base layer 110 so that the base layer 110 passes through a path in which a process may be performed by the spinning part 30 and the power supplying part 10.

First, the base layer 110 loaded on the transferring part 20 may be transferred to the power supplying part 10 side by the transferring part. Here, the power supplying part 10 may be disposed at a position adjacent to the spinning part 30, and may supply power to the base layer 110 when the spinning part 30 spins the nanofiber 1 on the base layer 110. Accurately, the nanofiber 1 may be spun by the spinning part 30 within a time for which power is supplied by the power supplying part 10.

The base layer 110 transferred by the transferring part 20 may be transferred to a position to which the power supplying part 10 may supply power. The transferring part 20 may stop transfer so that the base layer 110 is stopped at the position, and may also continuously transfer the base layer 110. This may be determined by the controlling part 40.

In a case in which the transfer is stopped at the position, the base layer 110 is stopped on the transferring part 20, and the spinning part 30 spins the nanofiber 1 on the base layer 110 while moving. Further, in a case in which the base layer 110 is continuously transferred by the transferring part 20, a spinning speed of the nanofiber 1 is determined to correspond to a transfer speed of the base layer 110, thereby forming the nanofiber layer 130.

Information on the spinning speed of the nanofiber 1, the transfer speed of the transferring part 20, and power supplied by the power supplying part 10 may be determined by the controlling part 40. The controlling part 40 may control the spinning part 30, the transferring part 20, and the power supplying part 10 by predetermined values. In particular, various signals may be secured by a change in resistance between the electrodes 120 by power supplied by the power supplying part 10.

The signal may increase foreign material adsorption efficiency when the filter performs the filtering function by the electric field formed between the electrodes 120 or around the electrode, and may induce the nanofiber 1 to be adsorbed well on the base layer 110 when the filter is manufactured.

Further, by applying a current in a manner selected from a continuous manner, a periodic manner, and a discontinuous manner to the electrode 120 during the filtering by the filter, the adsorption force acting on a foreign material may be adjusted, and an amount of the foreign material filtered out by the filter may be detected by detecting a change in the signal, that is, the resistance value by applying a current. For example, in a case in which the amount of foreign material filtered out through the filter by the electric field is increased, the resistance may be decreased, and when the decreased resistance is detected, a filter replacement signal may be displayed.

A lifespan of the filter, adsorption of the nanofiber 1 at the time of the manufacturing, and the foreign material adsorption performance of the filter through the electric field, or the like may be controlled or recognized through the signal described above.

Once the spinning of the nanofiber 1 is completed, the spinning by the spinning part 30 is stopped, the supply of power by the power supplying part 10 is stopped, and the transfer may be performed by the transferring part 20.

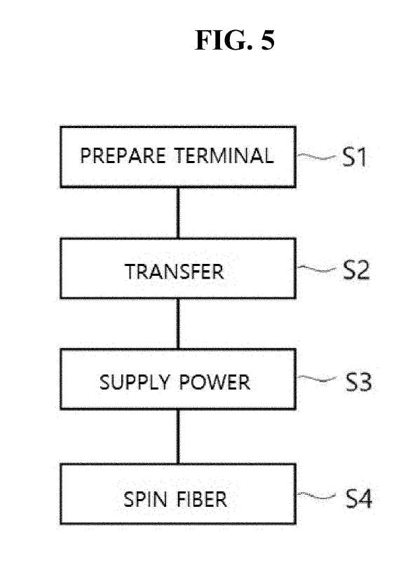

FIG. 5 is a flowchart illustrating a method for manufacturing a filter according to an embodiment of the present invention.

Referring to FIG. 5, the method for manufacturing a filter may include preparing one or more electrodes (S1), transferring (S2), supplying power (S3), and spinning fiber (S4). Specifically, one or more electrodes may be prepared on the base layer 110. The electrode 120 may be prepared for promoting adsorption of the nanofiber at the time of the manufacturing, and for improving the filtering function of the filter 100 after the filter 100 is manufactured. Therefore, the electrode prepared on the base layer 110 is prepared to be supplied with power from the power supplying part 10 even at the time of manufacturing, and is prepared to be supplied with power from the external device even after the manufacturing of the filter. For example, the electrode 120 may be positioned to be partially exposed from the filter 100 so that power may be supplied from an air conditioning apparatus or a water purifier in the case of being included in the air conditioning apparatus or the water purifier.

The filter 100 in which the electrode 120 is prepared as described above may be transferred by the transferring part 20 (S2). The filter 100 may be transferred to the spinning part 30 and the power supplying part 10 side. In other words, the filter 100 may be transferred to a distance at which the spinning part 20 spins the nanofiber 1 and the nanofiber 1 may be adsorbed on the base layer 110. The supplying of the power (S3) may be performed on the base layer 110 transferred to the spinning part 30 side. Power is supplied to the electrode 120 by the power supplying part 10 and the electrode 120 that is supplied with the power may generate an electric field. The electric field may allow the nanofiber 1 to be adsorbed, and the supplying of the power may be maintained during the spinning by the spinning part 30 so that the nanofiber 1 spun by the spinning part 30 may be adsorbed.

The spinning part 30 may spin the nanofiber 1 on the base layer 110 in a state of being supplied with power (S4). When the nanofiber 1 is spun on the base layer 110, since the electric field is formed by supplying power to the electrode 120, the nanofiber 1 may be adsorbed on the base layer 110 side around which the electric field is formed. It is possible to continuously maintain the state in which the nanofiber 1 is adsorbed on the base layer 110 by the adhesive property based on the viscosity of the nanofiber 1 in a liquid state.

After the manufacturing, the electrode 120 is not removed from the base layer 110 and may be exposed at a position that is advantageous for being supplied with power from the external device. It may be advantageous that the electrode 120 positioned to be exposed from the filter 100 is disposed at a predetermined position in a filtering apparatus to perform the filtering function when being supplied with power from the filtering apparatus. Therefore, when performing the filtering function, the electrode 120 may be supplied with power, and the electrode 120 supplied with the power may perform the filtering function while adsorbing fine particles, heavy metal, and the like together with the nanofiber layer 130.

Even if the electrode 120 is not present, the filtering function may be performed by the nanofiber layer 130, but the filtering function is only structurally performed according to the density of the nanofiber 130, and the foreign material may not be adsorbed through polarity. That is, the nanofiber layer 130 may filter out fine heavy metal, or the like that is not filtered out at the density by supplying power to the electrode 120.

In addition, as the electrode 120 performs the filtering function while being supplied with power from the external device, duration of a filtering effect, that is, a lifespan may be prolonged, and the adsorption force by the electric field may also be adjusted according to information of the supplied power.

According to an embodiment of the present invention, it is possible to provide a filter including a base layer and a nanofiber layer, in which the base layer and the nanofiber layer are more firmly coupled by an electric field generated by an electrode.

According to an embodiment of the present invention, it is possible to provide a filter including a base layer and a nanofiber layer, in which power is provided to increase force for adsorbing foreign materials and adsorptive force duration at the time of performing a filtering function.

According to an embodiment of the present invention, it is possible to provide an apparatus for manufacturing a filter including a base layer and a nanofiber layer, in which the base layer and the nanofiber layer are more firmly coupled by an electric field generated by an electrode.

According to an embodiment of the present invention, it is possible to provide a method for manufacturing a filter including a base layer and a nanofiber layer, in which the base layer and the nanofiber layer are more firmly coupled by an electric field generated by an electrode.

Although the representative embodiments of the present invention have been disclosed in detail, those having ordinary skill in the field of technology to which the present invention pertains would understand that various modifications are possible, without departing from the scope of the present invention. Accordingly, the scope of the present invention should not be construed as being limited to the described embodiments but be defined by the appended claims as well as equivalents thereof.

What is claimed is:

1. A filter, comprising:
an electrode;
a base layer comprising one side coupled with the electrode; and
a nanofiber layer spun on one side of the base layer and coupled,
wherein the coupling between the nanofiber layer and the base layer is performed as the nanofiber layer is adsorbed on the base layer by an electric field generated by supplying power to the electrode.

2. The filter of claim 1, wherein the electrode is formed of a metal or an alloy.

3. The filter of claim 1, wherein the electrode includes a coated area.

4. The filter of claim 1, wherein the electrode, the base layer, and the nanofiber layer have predetermined elasticity so that the filter is flexible.

5. The filter of claim 1, wherein the electrode is formed to have a diameter or a thickness of 0.5 mm or less to be flexibly bent.

6. The filter of claim 1, wherein the electrode is disposed between the base layer and the nanofiber layer.

7. The filter of claim 1, wherein the electrode extends while changing a direction thereof one time or more in a section in which the electrode extends from one end to the other end.

8. The filter of claim 1, wherein the electrode is coupled with the base layer by printing.

9. The filter of claim 1, wherein one or more of the electrode and the nanofiber layer includes silver having a sterilization function.

10. The filter of claim 1, wherein the electrode is formed in a film form and is coupled with the base layer through surface contact.

11. The filter of claim 1, further comprising:
a controlling part securing different signals depending on a change in resistance generated at both ends of the electrode and performing a control corresponding to the signal.

12. The filter of claim 11, wherein the signal corresponds to a resistance value, and an intensity of a current provided to the electrode is determined depending on the resistance value.

13. The filter of claim 1, wherein a current provided to the electrode is provided in a manner selected from a continuous manner, a periodic manner, and a discontinuous manner.

14. The filter of claim 1, wherein the electrode includes one or more of a positive electrode and a negative electrode.

15. The filter of claim 1, wherein a position at which the electrode and the base layer are coupled with each other includes an edge position of the base layer.

16. The filter of claim 1, further comprising:
a conductor or a semiconductor at one side of the base layer,
wherein nanofiber is electrospun on one side of the conductor or the semiconductor.

17. An apparatus for manufacturing a filter, comprising:
a transferring part transferring a base layer on which an electrode is prepared;
a spinning part spinning nanofiber on the base layer; and
a power supplying part supplying power to the terminal,
wherein the spinning part spins the nanofiber while the power is supplied.

18. A method for manufacturing a filter, comprising:
preparing a conductive terminal on one side of a porous base layer;
transferring, by a transferring part, the base layer to a spinning part;
supplying, by a power supplying part, power to the terminal; and
adsorbing nanofiber spun by the spinning part on the base layer by an electric field formed at the terminal.
